(19) United States
(12) Patent Application Publication
(10) Pub. No.: US 2011/0051462 A1
(43) Pub. Date: Mar. 3, 2011

(54) POWER FACTOR IMPROVEMENT CIRCUIT

(75) Inventors: Tetsuya Nakamura, Saitama (JP); Yukihiro Kaminaga, Saitama (JP)

(73) Assignee: SANKEN ELECTRIC CO., LTD., Saitama (JP)

(21) Appl. No.: 12/871,005

(22) Filed: Aug. 30, 2010

(30) Foreign Application Priority Data
Aug. 31, 2009 (JP) 2009-200055

(51) Int. Cl. H02M 3/335

(52) U.S. Cl. 363/17; 363/21.02

(57) ABSTRACT

An over-voltage protection circuit of the invention is connected with a DC-DC converter having a structure in which a plurality of switching elements is serially connected to a direct current output voltage terminal of a power factor improvement circuit. An output over-voltage detection resistance of a latch-type output over-voltage detection circuit is connected to a connection point at which the plurality of switching elements is connected.

### CROSS REFERENCE TO RELATED APPLICATIONS

This application claims priority from Japanese Patent Application No. 2009-200055 filed on Aug. 31, 2009, the entire subject matter of which is incorporated herein by reference.

### BACKGROUND OF THE INVENTION

1. Field of the Invention

The present invention relates to a protection circuit of a power factor improvement circuit.

2. Description of the Related Art

FIG. 4 shows one example of a related-art power factor improvement circuit. In FIG. 4, a sinusoidal voltage from an alternating power source 1 passes through a filter 2 and is full wave-rectified in a full-wave rectification circuit 3. Then, the rectified full-wave passes through a filter 4 and then is supplied to a power factor improvement circuit 5. The power factor improvement circuit 5 is a voltage step up active filter type including a main coil 67a of a choke coil 67, a switching element 68, a diode 70 and an output condenser 71. The power factor improvement circuit 5 includes a control circuit 6 as a control system.

Then, an operation of the related-art power factor improvement circuit 5 shown in FIG. 4 will be described. First, one end of a coil 67b for critical detection of the choke coil 67 is connected to a ground GND and the other end of the coil 67b is inputted to a plus (+) input terminal of a comparator 54 via a resistance 66 and a DET terminal. At the same time, a third reference voltage 53 is inputted to a minus (−) input terminal of the comparator 54. The comparator 54 compares the two inputted voltages and a set signal of a low level is outputted from the comparator 54 to a flip flop 62.

When the flip flop 62 is set in accordance with the set signal from the comparator 54, a drive signal of a high level is supplied from a Q output terminal to a gate terminal of the switching element 68 via an AND circuit 64, so that the switching element 68 turns on. When the switching element 68 turns on, switching current flows from the alternating power source 1 to the ground GND through the main coil 67a of the choke coil 67, drain/source of the switching element 68 and a resistance 69 for current detection. As a result, it is possible to accumulate energy in the choke coil 67.

At this time, the switching current flowing in the switching element 68 is converted into voltage by the resistance 69 for current detection provided between the source of the switching element 68 and the ground GND and is inputted to the plus (+) input terminal of the comparator 56. The switching current, which is converted into voltage by the resistance 69, is then compared in the comparator 56 with a current target value Vm outputted from a multiplier 55.

When the switching current reaches the current target value Vm, a reset signal of a high level is outputted from the comparator 56 to the flip flop 62 via an OR circuit 61. The flip flop 62 is reset in accordance with the reset signal from the comparator 56 and the drive signal of a high level outputted from the Q output terminal is converted into a low level, so that the switching element 68 turns off.

When the switching element 68 turns off, the energy accumulated in the choke coil 67 and the voltage supplied from the filter 4 are composed, and the composite voltage is then charged to an output condenser 71 via a diode 70. As a result, a voltage that is stepped up to be higher than a peak value of the rectified full-wave supplied from the filter 4 is outputted to the output condenser 71.

When the discharge of the energy accumulated in the choke coil 67 is completed, the coil voltage of the choke coil 67 is inverted. This coil voltage is detected by the coil 67b for critical detection of the choke coil 67 and is then inputted to the comparator 54 via the resistance 66 and the DET terminal. The comparator 54 compares the voltage from the DET terminal with the third reference voltage 53, and a set signal of a low level is outputted from the comparator 54 to the flip flop 62. As a result, the flip flop 62 is set in accordance with the set signal from the comparator 54, and a drive signal of a high level is again inputted to the gate terminal of the switching element 68, so that the switching element 68 turns on. In other words, when the discharge of the energy in the choke coil 67 is completed, the flip flop 62 is again set and the switching element 68 turns on.

The output voltage from the output condenser 71 is voltage-divided by resistances 73, 74, 75 and is inputted to an operational amplifier 57 through a CV terminal. Then, a differential signal between the inputted voltage and a first reference voltage 58 is amplified and is outputted by the operational amplifier 57, so that a resultant error signal is supplied to the multiplier 55.

The rectified full-wave from the filter 4 is voltage-divided by resistances 51, 52 and is inputted to the multiplier 55 through an AC terminal. The rectified full-wave and the error signal are multiplied by the multiplier 55, and the multiplied output is then supplied to the minus (−) input terminal of the comparator 56. The output of the multiplier 55 is increased/decreased in accordance with the output voltage of the rectified full-wave (ripple wave) and becomes the current target value Vm of the switching current detected through a CS terminal.

Then, the above operations are repeated, so that the output voltage Vo of the output condenser 71 of the power factor improvement circuit 5 is kept constant. Also, the current flowing in the alternating power source 1 becomes a sinusoidal current wave following the voltage of the alternating power source 1.

In addition, the power factor improvement circuit 5 includes a latch-type output over-voltage detection circuit 81 that stops the power factor improvement circuit 5 when the output voltage Vo becomes an over-voltage due to failure and the like. The latch-type output over-voltage detection circuit 81 voltage-divides the output voltage Vo of the power factor improvement circuit with resistances 83, 84 and enables a comparator 85 to compare the divided voltage with a reference voltage 86. For an over-voltage, the latch-type output over-voltage detection circuit outputs a high level from the comparator 85 to a latch circuit 87 to set the latch circuit 87 and transmits a stop signal to an OFF terminal of the control circuit 6 in order to stop the power factor improvement circuit 5.

In addition, in order to keep the output voltage Vo constant, the power factor improvement circuit 5 inputs a voltage of the resistance 75 of an output voltage detection circuit 72 including the resistances 73, 74, 75 to the operational amplifier 57 to perform a feedback control. However, in order to make the current in the alternating power source 1 be a sinusoidal wave form, it is necessary to sufficiently slow a response, correspondingly to a frequency of the sinusoidal wave. Due to this, a condenser 76 for relatively great phase compensation is connected between a FB terminal and the CV terminal. Thereby, it is possible to sufficiently slow a response, correspondingly to a frequency of the sinusoidal wave. However, since the response is slow, a problem is caused in which the output voltage is increased in a short time due to sudden changes in inputs and loads.

In order to solve the above problem, the control circuit 6 includes an OVP terminal that inputs a voltage at a connection point of the resistances 73, 74 to the OVP terminal. At this time, the voltage at the connection point of the resistances 73, 74 is set slightly higher than a voltage of the CV terminal. When a voltage higher than a second reference voltage 60 is inputted from the OVP terminal, a comparator 59 outputs a high level. The output of the comparator 59 resets the flip flop 62 through the OR circuit 61 and turns off the switching element 68. Thereby, the switching element 68 is turned off only during a period in which the output voltage Vo becomes an over-voltage and is thus increased due to sudden changes in inputs and loads, so that the output voltage Vo is prevented from being increased. Furthermore, as described in JP-A-2003-348848, in addition to the output voltage detection circuit 72, a non-latch type output over-voltage detection circuit (not shown) comprised of the same output voltage detection circuit may be added to improve a response speed of the OVP terminal. Further, as protection measures during the over-voltage, the latch-type output over-voltage detection circuit 81 is connected, so that the power factor improvement circuit 5 is stopped safely and certainly.

However, in the above-described related-art power factor improvement circuit, since the latch-type output over-voltage detection circuit 81 is connected, the consumption power of the power factor improvement circuit is consumed.

In addition, in the related-art power factor improvement circuit, the latch-type output over-voltage detection circuit 81 is connected between the output terminals of the power factor improvement circuit and is connected from the alternating power source through the full-wave rectification circuit 3, the choke coil 67a and the diode 70 even when the power factor improvement circuit is stopped such as a standby state of an electronic device. Accordingly, the consumption power by the latch-type output over-voltage direction circuit 81 does not disappear. Regarding recent TV receivers, it is attempted to reduce the consumption power to about 0.1 W under standby state of a remote control and to develop measures for saving energy. Thus, the increase in consumption power by the protection circuit is a big problem.

### SUMMARY OF THE INVENTION

An object of the invention is to provide a power factor improvement circuit in which loss at the time of standby due to a voltage detection resistance of an over-voltage protection circuit of the power factor improvement circuit is reduced and loss of an over-voltage detection resistance at the time of a normal operation is reduced.

According to one aspect of the invention, there is provided a power factor improvement system comprising: a power factor improvement circuit comprising: a choke coil, through which a rectified full-wave obtained by rectifying an alternating voltage supplied from an alternating power source is input; and a first switching element that is switched on/off for rectification-smoothening the rectified full-wave so as to obtain a direct current output voltage; an output voltage detection circuit that detects the output voltage to obtain a first detected voltage so as to control the output voltage at a constant value; a latch-type output over-voltage detection circuit, which compares the output voltage with an over-voltage reference voltage for detecting an over-voltage state of the output voltage, and which latches an output indicating that the output voltage reaches the over-voltage reference voltage; a control circuit that controls the first switching element to switch on/off based on the first detected voltage obtained in the output voltage detection circuit and the latched output from the latch-type output over-voltage detection circuit; and a DC-DC converter comprising a plurality of switching elements that are serially connected between direct current output voltage terminals of the power factor improvement circuit, wherein a positive detection terminal of an output over-voltage detection resistance of the latch-type output over-voltage detection circuit is connected to a connection point between the plurality of switching elements.

According to another aspect of the invention, in the power factor improvement system, wherein the DC-DC converter is a current resonance type.

According to still another aspect of the invention, in the power factor improvement system, wherein the DC-DC converter is a bridge type.

According to the invention, the loss at the time of the standby of an electronic device, which is caused due to the over-voltage detection resistance of the power factor improvement circuit, is removed and the power at the time of the standby of the electronic device can be thus reduced. In addition, since it is not necessary to consider the power at the time of standby, it is possible to make the over-voltage detection resistance be relatively small. According thereto, it is possible to increase a degree of freedom of the design and to improve the foreign noise tolerated dose of the over-voltage protection circuit.

### BRIEF DESCRIPTION OF THE DRAWINGS

FIG. 1 is a diagram of a direct current power source circuit including a power factor improvement circuit according to an exemplary embodiment of the invention;

FIG. 2 illustrates an output voltage of a power factor improvement circuit and a voltage waveform of a switching element of a DC-DC converter;

FIG. 3 is a diagram of a power factor improvement circuit and an over-voltage protection circuit relating to an application of an exemplary embodiment of the invention and the DC-DC converter; and

FIG. 4 is a diagram of a power factor improvement circuit and an over-voltage protection circuit according to a related art.

### DETAILED DESCRIPTION OF THE PREFERRED EMBODIMENTS

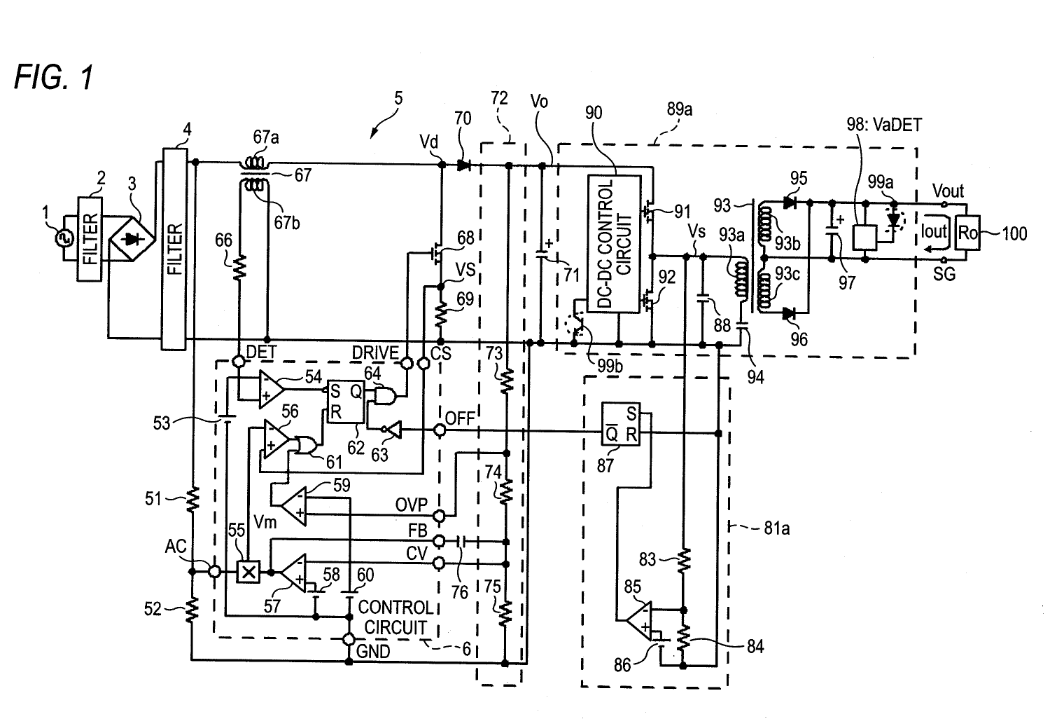

FIG. 1 is a diagram of a direct current power source circuit including a power factor improvement circuit according to an exemplary embodiment of the invention. In an over-voltage protection circuit 81, which functions as a latch-type output over-voltage detection circuit, of a power factor improvement circuit according to the exemplary embodiment, an over-voltage detection terminal (positive terminal) of the over-voltage protection circuit 81 is connected to a connection point of switching elements 91, 92 of a DC-DC converter 89a. Incidentally, an over-voltage detection terminal (negative terminal) of the over-voltage protection circuit 81 is connected to a line common to the ground GND terminal of the power factor improvement circuit.

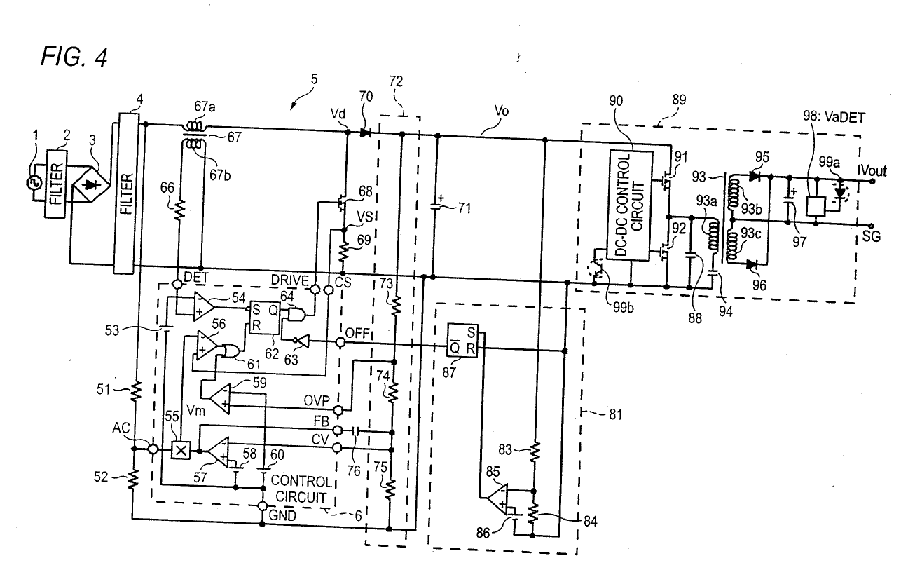

The power factor improvement circuit 5 having the over-voltage protection circuit shown in FIG. 1 has a structure in which the DC-DC converter 89a is connected to an output of the power factor improvement circuit 5. A structure of the power factor improvement circuit 5 is the same as the circuit diagram of the related art shown in FIG. 4. Although the over-voltage protection circuit 81 has similar structure as that of the related-art circuit diagram shown in FIG. 4, a connection for over-voltage detection is different from the related-art circuit and is connected to a connection portion between switching elements of a half bridge structure of the DC-DC converter 89a. Herein, the same or similar reference numerals are used for the same or similar parts as or to those of the related-art circuit shown in FIG. 4.

The DC-DC converter 89a is structured with a resonance-type switching power source such as a current resonance-type direct current power source, for example. The resonance-type switching power source has high-side and low-side switching elements 91, 92, which are serially connected between positive and negative terminals of an output voltage terminal of the power factor improvement circuit, a resonance circuit that is parallel connected to the low-side switching element 92 and includes a primary coil 93a of a transformer 93 and a current resonance condenser 94 and a voltage resonance condenser 88. As the high-side and low-side switching elements 91, 92 are alternately turned on and off, resonance current is made to flow to a primary inductance including leakage inductance of the transformer 93 and the current resonance condenser. At this time, a voltage that is obtained at a secondary coil 93b or 93c of the transformer 93 is rectified through a diode 95 or 96, so that a DC voltage is obtained at the output side.

The resonance-type switching power source adopts a pulse frequency modulation (PFM) control manner of changing a switching frequency to control an output voltage. Regarding the switching frequency of the PFM control, when an output voltage is controlled at a frequency region higher than a resonance frequency, the switching frequency is increased to lower an output voltage and is lowered to increase an output voltage. In this case, in order to feedback the output voltage Vout to obtain a stable output voltage, an output voltage and an internal reference voltage (not shown) are compared by an error amplifier 98 and a feedback signal is outputted to a DC-DC control circuit 90 at a primary side through photo-couplers 99a, 99b. The DC-DC control circuit 90 at the primary side controls the switching frequencies of the switching elements 91, 92 so that the output voltage Vout is stable.

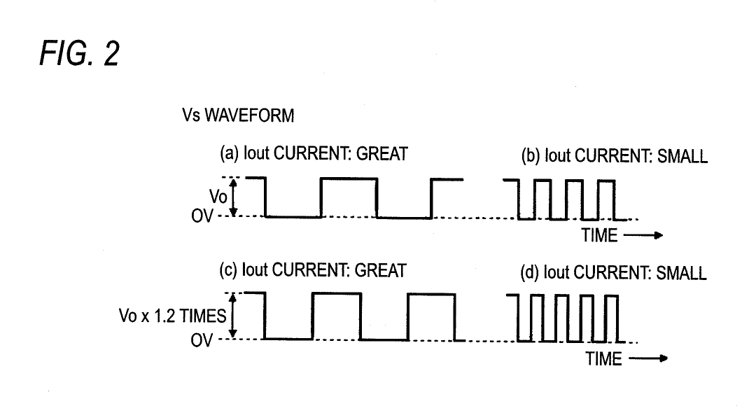

FIG. 2 illustrates an output voltage of the power factor improvement circuit and a voltage waveform of a switching element of the DC-DC converter. FIG. 2 shows a drain voltage Vs of the low-side switching element 92 when load current lout is changed.

Herein, as the voltage Vs of the connection point of the high-side and low-side switching elements 91, 92 makes an on/off operation between the output voltage Vo of the power factor improvement circuit and the ground GND, the output voltage Vo of the power factor improvement circuit can be detected. In addition, when the high-side and low-side switching elements 91, 92 are not turned on/off, a voltage is not applied to the detection resistances 83, 84 of the over-voltage protection circuit 81. In other words, under standby state in which the DC-DC converter 89a does not operate, the power loss of the resistances 83, 84 is not caused.

Furthermore, the voltage Vs of the connection point of the high-side and low-side switching elements 91, 92 is a pulse waveform having a duty of about 50%, regardless of the load current, and the loss of the detection resistances 83, 84 of the over-voltage detection circuit 81 is reduced by about ½, compared to a case where they are connected to the output voltage terminal of the power factor improvement circuit.

According to the above exemplary embodiment, during the standby state, the power factor improvement circuit and the DC-DC converter connected to a rear end thereof are stopped. Thereby, it is possible to reduce the loss of the detection resistance of the over-voltage protection circuit of the power factor improvement circuit.

In addition, in the related art, a range of the detection resistance is limited due to the loss of the detection resistance and an input impedance from a standpoint of preventing a malfunction of the over-voltage protection circuit. In contrast, according to the exemplary embodiment, the resistance loss is proportional by the on/off duty ratio of the DC-DC converter. Thus, it is possible to reduce the resistance loss by the duty or to decrease the detection resistance value of the over-voltage protection circuit, thereby reducing the impedance of the protection circuit input part to further prevent the malfunction.

While the present invention has been described with reference to the exemplary embodiment, it should be noted that the invention is not limited to the exemplary embodiment. For example, the DC-DC converter is not limited to the current resonance type and may be arbitrarily set such as half bridge/forward type and full bridge/forward type.

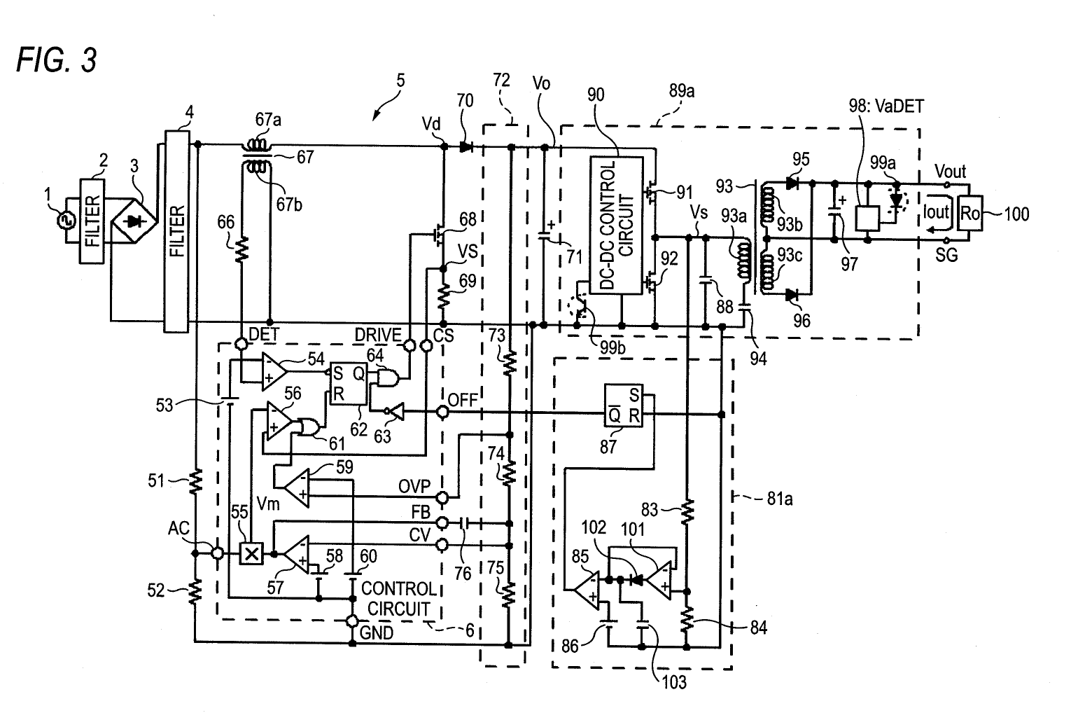

In addition, FIG. 3 is a diagram of a power factor improvement circuit and an over-voltage protection circuit relating to an application of an exemplary embodiment of the invention and a DC-DC converter. As shown in FIG. 3, a peak hold circuit is connected to the input part of the over-voltage protection circuit. Thus, the pulse voltage detection is converted into a DC voltage detection, so that the noise tolerated dose can be further enhanced.

What is claimed is:

1. A power factor improvement system comprising:
a power factor improvement circuit comprising:
a choke coil, through which a rectified full-wave obtained by rectifying an alternating voltage supplied from an alternating power source is input; and
a first switching element that is switched on/off for rectification-smoothening the rectified full-wave so as to obtain a direct current output voltage;
an output voltage detection circuit that detects the output voltage to obtain a first detected voltage so as to control the output voltage at a constant value;
a latch-type output over-voltage detection circuit, which compares the output voltage with an over-voltage reference voltage for detecting an over-voltage state of the output voltage, and which latches an output indicating that the output voltage reaches the over-voltage reference voltage;
a control circuit that controls the first switching element to switch on/off based on the first detected voltage obtained in the output voltage detection circuit and the latched output from the latch-type output over-voltage detection circuit; and
a DC-DC converter comprising a plurality of switching elements that are serially connected between direct current output voltage terminals of the power factor improvement circuit,
wherein a positive detection terminal of an output over-voltage detection resistance of the latch-type output over-voltage detection circuit is connected to a connection point between the plurality of switching elements.

2. The power factor improvement system according to claim 1, wherein the DC-DC converter is a current resonance type.

3. The power factor improvement system according to claim 1, wherein the DC-DC converter is a bridge type.
